(19) United States
(12) Patent Application Publication
(10) Pub. No.: US 2021/0233437 A1
(43) Pub. Date: Jul. 29, 2021

(54) SIGN ASSEMBLY

(71) Applicants: William Brian Vincil, Royal Oak, MI (US); Michelle Lee DeBroux-Vincil, Royal Oak, MI (US)

(72) Inventors: William Brian Vincil, Royal Oak, MI (US); Michelle Lee DeBroux-Vincil, Royal Oak, MI (US)

(21) Appl. No.: 17/136,374

(22) Filed: Dec. 29, 2020

Related U.S. Application Data
(60) Provisional application No. 62/995,334, filed on Jan. 24, 2020.

(51) Int. Cl. G09F 7/18; G09F 13/02

(52) U.S. Cl. CPC G09F 7/18; G09F 2007/186; G09F 2007/1847; G09F 13/02

(57) ABSTRACT

A sign assembly may include a base, a main member, a brace arm, and an accessory arm. The base may be removably attached to a support surface. The main member may extend from the base opposite the support surface. The brace arm may extend from the main member and towards the support surface. The main member may selectively engage and support a sign, interchangeable by a user. The accessory arm may be selectively connected and operably engaged with the main member. The accessory arm may extend from the main member and support at least one accessory. The at least one accessory may include a light source, a power source, a camera, and a controller.

### CROSS-REFERENCE TO RELATED APPLICATIONS

This application claims the benefit of U.S. provisional application Ser. No. 62/995,334 filed Jan. 24, 2020, the disclosure of which is hereby incorporated in its entirety by reference herein.

### TECHNICAL FIELD

This present disclosure generally relates to sign assemblies and methods, including sign assemblies and methods that may be used in conjunction with an entrance to a structure.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Sign assemblies may be fixedly attached to a support such that they are visible to an observer. Sign assemblies may be used as indicators and/or provide information to the observer. However, prior art sign assemblies may not include sufficient functionality or features.

There is a desire for solutions/options that improve prior art sign assemblies. The foregoing discussion is intended only to illustrate examples of the present field and are not a disavowal of scope.

### SUMMARY

With embodiments, a sign assembly may include a base and a main member. The base may be removably attached to a support surface. The main member may extend from the base opposite the support surface. The main member may selectively engage and support a sign, interchangeable by a user.

In embodiments, a sign assembly may include a mount, a base, and a main member. The mount may be removably or fixedly attached to a support surface. The mount may support the base and may be selectively engageable with the mount. The main member may extend from the base and may support a sign, selectively engageable and interchangeable by a user.

With embodiments, a sign assembly may include a base, a main member, and a brace arm. The base may be removably attached to a support surface. The main member may extend from the base opposite the support surface. The brace arm may be selectively connected to the main member and extend towards the support surface, configured to brace the sign assembly against the support surface. The main member may selectively engage and support a sign, interchangeable by a user.

In embodiments, a sign assembly may include a base, a main member, and an accessory arm. The base may be removably attached to a support surface. The main member may extend from the base opposite the support surface. The main member may selectively engage and support a sign, interchangeable by a user. The accessory arm may be selectively connected and operably engaged with the main member. The accessory arm may extend from the main member and support at least one accessory. The at least one accessory may include a light source, an power source, a camera, and an controller.

With embodiments, a sign assembly may include a controller. The controller may communicate with a vehicle, a mobile phone, other controllers. The controller may be configured to turn on the power source to power the light source and/or change the color of the light source and/or cause the light source to intermittently turn off and on. The controller may be configured to receive an emergency signal when an occupant of the structure contacts an emergency service. The controller, after receiving the signal, may be configured to turn on the power source to power the light source and/or change the color of the light source and/or cause the light source to intermittently turn off and on. Additionally or alternatively, the controller may broadcast a location signal. The light source and/or the controller may be configured to act as an indicator to a mobile phone user and/or autonomous transportation seeking or confirming a destination.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and are not restricted to the precise form and configuration shown in the drawings or disclosed in the following detailed description. Exemplary illustrations are described in detail by referring to the drawings as follows:

FIG. 1 generally illustrates an embodiment of a sign assembly according to teachings of the present disclosure.

FIG. 2 generally illustrates an embodiment of a sign assembly according to teachings of the present disclosure.

FIG. 3A generally illustrates an embodiment of a sign assembly according to teachings of the present disclosure.

FIG. 3B generally illustrates an embodiment of a sign assembly according to teachings of the present disclosure.

FIG. 3C generally illustrates an embodiment of a sign assembly according to teachings of the present disclosure.

FIG. 3D generally illustrates an embodiment of a sign assembly according to teachings of the present disclosure.

FIG. 4 generally illustrates an embodiment of a sign assembly according to teachings of the present disclosure.

FIG. 5 generally illustrates an embodiment of a sign assembly according to teachings of the present disclosure

### DETAILED DESCRIPTION

While the claims are not limited to a specific illustration, an appreciation of various aspects may be gained through a discussion of various examples. As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Further, the exemplary illustrations described herein are not exhaustive or otherwise limiting, and are not restricted to the precise form and configuration shown in the drawings or disclosed below. Therefore, specific structural and functional details disclosed herein are not to be interpreted as limiting, but merely as a representative basis for teaching one skilled in the art to variously employ the present invention.

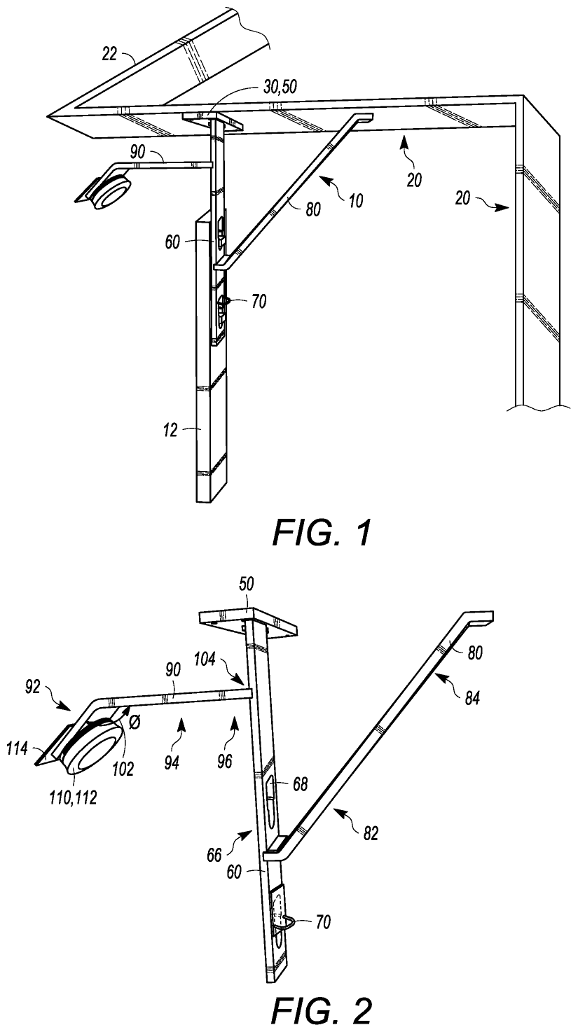

In embodiments, a sign assembly 10 capable of supporting a sign 12 is generally illustrated in FIG. 1. The sign assembly 10 may be removably attached to a support surface 20 of a structure 22. For example and without limitation, the sign assembly may be removably mounted to a soffit, a fascia, a beam, a board, or a wall with a fastener, a magnet, a hook, a clamp, a snap, a clip, a sleeve, or hook and loop. The sign assembly 10 may be made of any suitable material. For example and without limitation, the sign assembly 10 may be made of plastic, metal, or wood, such as high-density polyethylene (HDPE), poly(methyl methacrylate) (acrylic), polyvinyl chloride (PVC). The sign assembly 10 may be manufactured by any suitable method. For example and without limitation, the sign assembly 10 may be manufactured by injection molding, a computer numerical control (CNC) operation, or machined by a secondary process.

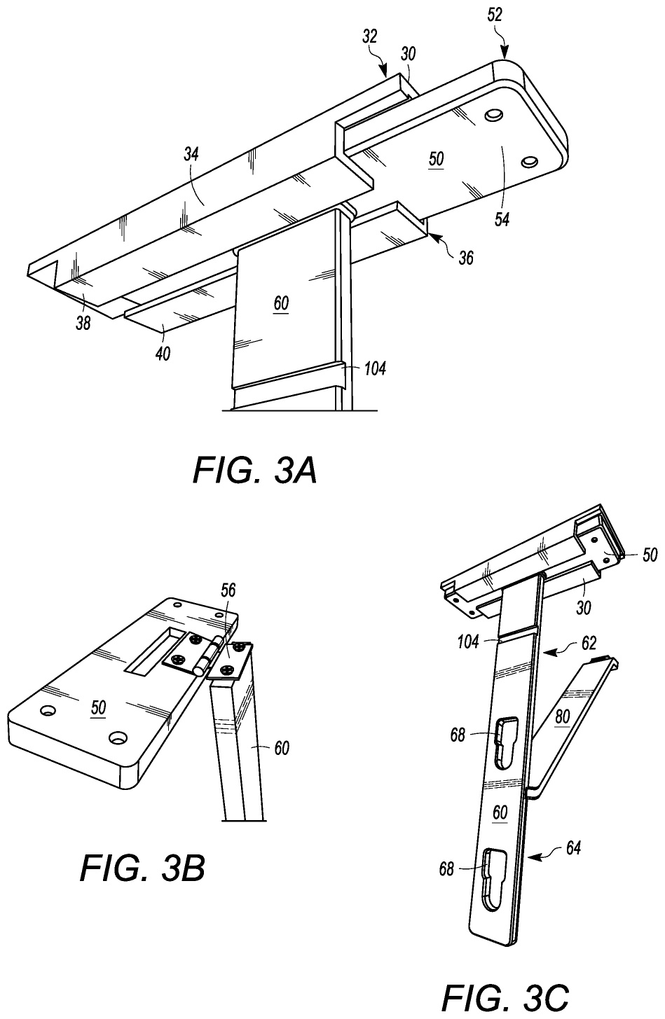

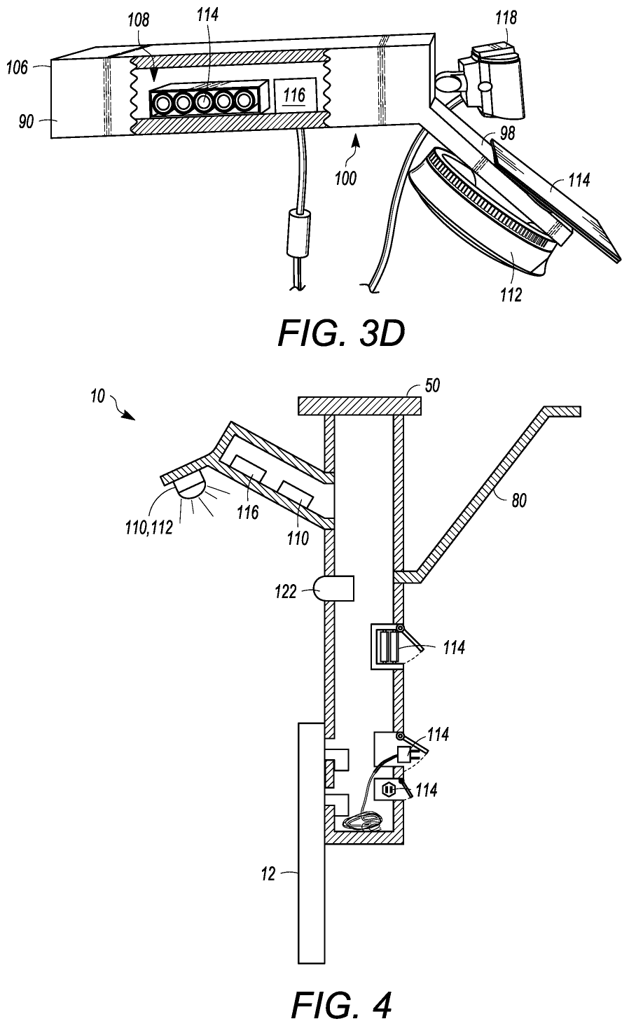

With embodiments, the sign assembly 10 may have a mount 30 that is removably attached to a support surface 20 as generally illustrated in FIG. 3A. The mount may have a mount wall 32, a first side wall 34 extending from the periphery of the mount wall 32 and a second side wall 36 extending from the periphery of the mount wall 32 opposite the first side wall 34. The mount may have a first retaining wall 38 extending from the first side wall 34 and a second retaining wall 40 extending from the second side wall 36, opposite and spaced apart from the first retaining wall 38. The mount wall 32, the first side wall 34, the second side wall 36, the first retaining wall 38, and the second retaining wall 40 may define a space 42 corresponding to the base 50. For example and without limitation, the first side wall 34 and the second side wall 36 may be parallel to each other and orthogonal to the mount wall 32. In a further example, the first retaining wall 38 and the second retaining wall 40 may be co-planar and extend towards each other.

With embodiments, the sign assembly 10 may have a base 50 as generally illustrated in FIGS. 2-3C. The base 50 may be removably attached to the support surface 20 using any attachment scheme previously described. The base 50 may have a first surface 52 and a second surface 54 opposite the first surface 52. The first surface 52 may be adjacent the support surface 20 when the base 50 is removably attached. Alternatively, the base 50 may cooperate with the mount 30 to removably attach the sign assembly 10 to the support surface 20. The first surface 52 may be adjacent the mount wall 32 and the second surface 54 may be adjacent the first retaining wall 38 and the second retaining wall 40 when the base 50 and the mount 30 are selectively engaged. For example and without limitation, the base 50 may be a panel that slides into the corresponding space 42 of the mount 30.

In embodiments, the sign assembly 10 may have a main member 60 as generally illustrated in FIGS. 1-2. The main member 60 may have an elongated body 66 with a first region 62 and a second region 64 opposite the first region 62. The first region 62 may be attached to and extend from the second surface 54 of the base 50. The connection between the main member 60 and the base 50 may be reinforced by a gusset as is known in the art. The main member 60 may extend from the base 50 such that when the base 50 is engaged with the mount 30, the first region 62 is adjacent to and passes between the first retaining wall 38 and the second retaining wall 40. Alternatively and additionally, the main member 60 may be rotatably connected to the base 50 via a hinge 56. For example and without limitation, the base 50 may be removably attached to the support surface 20 (e.g. a vertical wall) and the main member 60 may rotate relative to the base 50 via a hinge such that the main member 60 is parallel to the wall and coplanar with the base 50. Alternatively and additionally, as shown in FIG. 4, the main member 60 may be a hollow body with a space inside the body for housing an accessory 110. The main member 60 may be at least partially enclosed to protect any accessories 110 from inclement weather (e.g. rain or snow), insects, birds, and/or tampering. For example and without limitation, the main member 60 may house an at least partially enclosed space to store a power source 114 that is still accessible from the outside or a motion sensor 122.

With embodiments, the main member 60 may provide support for a sign 12. An interchangeable sign 12 may be selectively engaged with the main member 60 at the discretion of a user. The main member 60 may allow selective engagement by providing half of a first attachment scheme 68 while the sign 12 has the respective corresponding half. The first attachment scheme 68 can include but is not limited to magnets, hook and eye, keyhole slot and pin, clamp, snap fit, clip, sleeve, tongue and groove, or hook and loop. For example and without limitation, the main member 60 may have at least one keyhole slot disposed on the second region 64 with a corresponding pin on the sign 12, sized such that the keyhole slot on the main member 60 can engage and secure the pin on the sign 12. Alternatively and additionally, the main member 60 may have a resilient securing tab 70. The securing tab 70 may be used in conjunction with the first attachment scheme 68 to secure and stabilize the sign 12 against the main member 60. For example and without limitation, the securing tab 70 may be attached to the main member 60 above a keyhole slot such that it partially or fully covers the keyhole slot. A pin on the sign 12 may be inserted into the keyhole slot and push the securing tab 70 away from the main member 60 such that the pin may be seated and locked in the keyhole slot. The resilient securing tab 70 may provide a force on the pin to secure the pin to the main member 60. Alternatively and additionally, the securing tab 70 may be configured to provide a force to the sign 12 facilitating the continued engagement of the first attachment scheme 68.

In embodiments, the sign assembly 10 may have a brace arm 80 as generally illustrated in FIGS. 1-2. The brace arm 80 may be attached to the sign assembly such that the brace arm provides additional support and braces the sign assembly 10 against the support surface 20. The brace arm 80 may have a fixed region 82 and a brace region 84. The fixed region 82 of the brace arm 80 may be attached to the main member 60 and extend from the main member 60 towards the support surface 20. The brace region 84 may be adjacent the support surface 20.

With embodiments, the sign assembly 10 may have an accessory arm 90 as generally illustrated in FIGS. 1, 2, and 3D. The accessory arm 90 may have a free end 92, an elongated body 94, and a support end 96 adjacent the elongated body 94 and opposite the free end 92. The accessory arm 90 may be selectively engageable with the main member 60 at the discretion of a user. The accessory arm 90 may be selectively engageable with the main member using a second attachment scheme 104, similar to the first attachment scheme 68 previously described. For example and without limitation, the main member 60 may have a groove disposed on the elongated body 66 and the support end 96 of the accessory arm 90 may have a corresponding tongue sized to engage and secure the accessory arm 90 to the main member 60. The accessory arm 90 may be located on and extend from the main member 60 on a side and direction opposite the brace arm 80. For example and without limitation, the brace arm 80 may be attached to and extend from the rear of the main member 60 and the accessory arm 90 may be engaged on and extend from the front of the main member 60. The accessory arm 90 may have a top surface 98 and a bottom surface 100 opposite the top surface 98. The free end 92 may form an angle, θ, 102 with the elongated body 94. The angle θ 102 may be between 0 degrees and 180 degrees, or more preferably, 10 degrees to 170 degrees, or yet more preferably, 20 to 160 degrees. The accessory arm 90 may have a housing 106. The housing 106 may be integrated with the accessory arm 90 and may extend the length of the accessory arm 90 (i.e. from the support end 96 through the elongated body 94 towards the free end 92). The housing 106 may provide an enclosure 108 disposed on the accessory arm 90 to house and/or protect at least one accessory 110.

In embodiments, the at least one accessory 110 may include a light source 112, a power source 114, a motion sensor 122, and/or a controller 116. For example and without limitation, the accessory arm may support at least one of a camera, antenna, modem, router, circuit board, sensor, processor, radio frequency (such as WiFi) transceiver, radar sensor, relays, and a lidar sensor. The light source 112 may include but not be limited to a lightbulb, such as Philips—Hue White & Color Ambiance A19 Bluetooth Smart LED Bulb—Multicolor Model:548487. The light source 112 may be attached to the accessory arm 90. For example and without limitation, the light source 112 may be attached to the bottom surface 100 of the accessory arm 90 near the free end 92, such that the light source 112 illuminates a sign 12 engaged with the main member 60. A further example, the light source 112 may be configured to change colors. In yet a further example, the light source 112 may be configured to turn off and on based on a timer. In a further yet example, the light source 112 may be configured to turn on and off based on a measured level of ambient light. For example and without limitation, the light source 112 may turn on at or around dusk and turn off at or around dawn. Additionally or alternatively, the light source 112 may be a smart light bulb configured to connect to and be controlled by a smart device (e.g. a virtual assistant). For example and without limitation, the light source 112 may be part of Phillips Hue White ambiance Starter kit B22 model 8718699719111 that is configured to be controlled by a smart device, remote switch, or mobile application.

With embodiments, the accessory arm 90 may support a power source 114 configured to provide power to the other accessories 110. The power source 114 may include, but not be limited to, solar panel, battery, wireless charging, alternating current (AC), and direct current (DC). For example and without limitation, the power source 114 may be a solar panel attached to the top surface 98 of the accessory arm 90, near the free end 92. In a further example, the power source 114 may be a battery pack housed inside the enclosure 108 of the housing 106. Although the illustrated embodiment shows a power source 114 supported by the accessory arm, the power source 114 may also be external to the sign assembly 10 and configured to provide power to the sign assembly 10. For example, the power source 114 may be an electrical socket associated with the structure 22 and provided to the sign assembly 10 via an extension cord, such as GE Designer Extension Cord With Surge Protection, Braided Power Cord, 8 ft, 3 Grounded Outlets, Flat Plug.

In embodiments, the accessory arm 90 may support a controller 116. For example and without limitation, the controller 116 may be housed within the enclosure 108 of the housing 106. The controller 116 may be configured to control the power source 114, the light source 112, the camera 118, and wirelessly communicate with vehicles 120, mobile phones 140, and other controllers 160. The controller 116 may be configured to wirelessly communicate with a network, a mobile application, and a remote server (e.g., a cloud server). For example and without limitation, the controller 116 may be configured to communicate via Bluetooth®, Wi-Fi, and other radio frequency means.

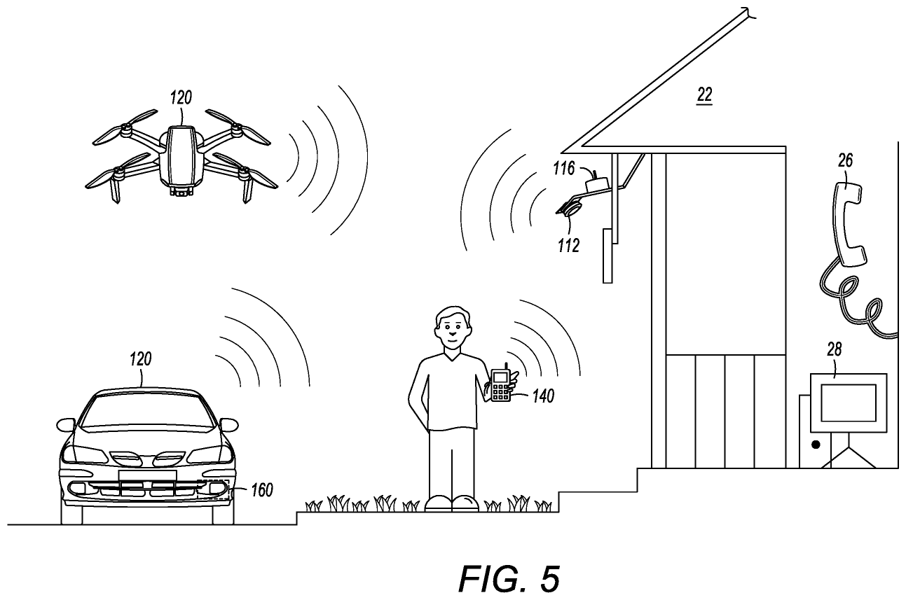

With embodiments, the controller 116 may be configured to provide an indicator to people or objects outside the structure 22 as generally illustrated in FIG. 5. For example and without limitation, the controller 116 may be configured to communicate with the power source 114 to provide power to the light source 112. The light source 112 may change colors (e.g., turn red), and/or it may intermittently turn off and on. Another example and without limitation, the controller 116 may include a commercially-available global position system (GPS) receiver and be configured to broadcast a GPS location as a secondary indicator such that a mobile phone 140 or other controller 160 may use the broadcast to home in the location of the sign assembly 10 and therefore the structure 22. For example and without limitation, a ride share application may provide instructions to the driver of the ride share vehicle to the location of an occupant of the structure 22—a primary indicator. As the ride share driver approaches the structure 22, the ride share application may receive the broadcast and use the broadcast to home in at the proper location—a secondary indicator. In a further example and without limitation, an autonomous vehicle 120 with another controller 160 may be configured to receive the broadcast to act as a secondary indicator to confirm that the autonomous vehicle arrives at the proper location. The controller 116 may broadcast the GPS location manually (e.g. an occupant of the structure 22 may instruct the controller 116 to start broadcasting the signal) or the controller 116 may do so automatically.

With embodiments, the accessory arm 90 may support a camera 118, such as Blink XT2 Outdoor/Indoor Smart Security Camera with cloud storage included, 2-way audio, 2-year battery life. The camera 118 may be in communication with the controller 116 and the power source 114. For example and without limitation, the controller 116 may be configured to communicate with the power source 114 to provide power to the camera 118. The camera 118 may be configured to monitor the outside (e.g. entrance, roadside, sidewalk, etc.) of the structure 22. For example and without limitation, the camera 118 may be configured to be a security measure to monitor for visitors, deliveries, or intruders.

In embodiments, the controller 116 may be in communication with a network associated with the structure 22. The network may monitor the structure 22 for outgoing electronic communication (e.g. phone calls, communications via mobile phone applications or websites) to emergency services (e.g. police, ambulance, etc.). For example and without limitation, when a phone call to emergency services is detected and identified, the controller 116 may be configured to communicate with the power source 114 to provide power to the light source 112. The light source 112 may change colors (e.g. turn red), and/or it may intermittently turn off and on (e.g. blink). Another example and without limitation, when a medical alert device contacts emergency services, the medical alert device also communicates with the controller 116, whereby the controller 116 may be configured to communicate with the power source 114 to provide power to the light source 112. The light source 112 may change colors (e.g. turn red), and/or it may intermittently turn off and on (e.g. blink). The controller 116 may be configured to broadcast a global position system (GPS) location such that a mobile phone 140 or other controller 160 may use the broadcast to home in the location of the sign assembly 10 and therefore the structure 22.

With embodiments, the controller 116 may also monitor communications to ride share companies and may illuminate or flash the light source 112 as an indicator which can be used to help guide ride share drivers to the structure 22.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

In examples, a controller 116, 160 may include an electronic controller and/or include an electronic processor, such as a programmable microprocessor and/or microcontroller. In embodiments, a controller 116, 160 may include, for example, an application specific integrated circuit (ASIC). A controller 116, 160 may include a central processing unit (CPU), a memory (e.g., a non-transitory computer-readable storage medium), and/or an input/output (I/O) interface. A controller 116, 160 may be configured to perform various functions, including those described in greater detail herein, with appropriate programming instructions and/or code embodied in software, hardware, and/or other medium. In embodiments, a controller 116, 160 may include a plurality of controllers.

It should be understood that a controller 116, 160, a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the use of examples/embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

What is claimed is:

1. A sign assembly adapted for attachment to a support surface, comprising:
a base; and
a main member, extending from the base, configured to support a sign when the sign is selectively engageable and disengageable to the main member.

2. The sign assembly of claim 1, further comprising a mount adapted for mounting to the support surface and selectively engageable and disengageable with the base.

3. The sign assembly of claim 2, wherein the mount has a mounting surface adjacent to the support surface, a first side wall extending from the mounting surface, a second side wall extending from the mounting surface opposite the first wall, a first retaining wall extending from the first side wall, a second retaining wall extending from the second side wall and spaced from the first retaining wall; wherein the first side wall, the second side wall, the first retaining wall, and the second retaining wall define a space where the base selectively engages the mount.

4. The sign assembly of claim 3, wherein the base has a surface with the main member extending from the surface and wherein the surface is adjacent the spaced apart first and second retaining walls when the base and the mount are engaged.

5. The sign assembly of claim 1, furthering comprising a brace arm extending from the main member and configured to brace the sign assembly against the support surface.

6. The sign assembly of claim 5, wherein the brace arm is selectively engageable and disengageable.

7. The sign assembly of claim 1, further comprising an accessory arm extending from the main member, wherein the accessory arm is configured to support at least one accessory.

8. The sign assembly of claim 7, wherein:
the accessory arm is selectively engagable and disengageable with the main member; and
one of the main member and the accessory arm has a groove and the other has a corresponding tongue, such that they are selectively engaged with a tongue-and-groove connection.

9. The sign assembly of claim 7, wherein the accessory arm has a free end, an elongated body, and a support end opposite the free end; wherein the free end forms an angle with the elongated body; and wherein the angle is between 0 degrees and 180 degrees.

10. The sign assembly of claim 9, wherein the at least one accessory is attached to the free end.

11. The sign assembly of claim 7, wherein the at least one accessory includes a light source, a power source, a camera, and a controller.

12. The sign assembly of claim 7, further comprising a housing integrated with the accessory arm to house the at least one accessory.

13. The sign assembly of claim 1, wherein a sign is selectively supported on the main member.

14. The sign assembly of claim 13, wherein one of the sign and the main member includes at least one key hole slot and the other includes a corresponding pin, such that they are selectively engaged with a key-hole-slot-and-pin connection.

15. A sign assembly, comprising:
a mount, attachable to a support surface when mounted;
a base, selectively connectable and removable from the mount;
a main member, extending from the base opposite the mount and capable of supporting a sign when selectively engaged; and
an accessory arm extending from the main member and capable of supporting at least one accessory.

16. The sign assembly of claim 15, wherein the at least one accessory includes at least one of a light source, a power source, a camera, and a controller.

17. The sign assembly of claim 16, wherein the mount has a mounting surface adjacent to the support surface, a first side wall extending from the mounting surface, a second side wall extending from the mounting surface opposite the first wall, a first retaining wall extending from the first side wall, a second retaining wall extending from the second side wall and spaced from the first retaining wall; wherein the first side wall, the second side wall, the first retaining wall, and the second retaining wall define a space where the base selectively engages the mount.

18. The sign assembly of claim 15, wherein the accessory arm has a free end, an elongated body, and a support end opposite the free end; wherein the free end forms an angle with the elongated body; and wherein the angle is between 0 degrees and 180 degrees.

19. The sign assembly of claim 15, wherein the accessory arm further comprises a housing integrated with the accessory arm to house the at least one accessory.

20. The sign assembly of claim 15, furthering comprising a brace connected to the main member extending towards the support surface and configured to brace the sign assembly against the support surface.
